(19) United States
(12) Patent Application Publication
(10) Pub. No.: US 2014/0044307 A1
(43) Pub. Date: Feb. 13, 2014

(54) SENSOR INPUT RECORDING AND TRANSLATION INTO HUMAN LINGUISTIC FORM

(71) Applicants: Jason B. Kenagy, La Jolla, CA (US); John J. Hannan, San Diego, CA (US); Kenneth Kaskoun, La Jolla, CA (US)

(72) Inventors: Jason B. Kenagy, La Jolla, CA (US); John J. Hannan, San Diego, CA (US); Kenneth Kaskoun, La Jolla, CA (US)

(73) Assignee: QUALCOMM LABS, INC., San Diego, CA (US)

(21) Appl. No.: 13/572,324

(22) Filed: Aug. 10, 2012

(51) Int. Cl. G06K 9/20

(52) U.S. Cl. CPC G06K 9/20
USPC 382/103

(57) ABSTRACT

Systems, methods, and devices use a mobile device's sensor inputs to automatically draft natural language messages, such as text messages or email messages. In the various embodiments, sensor inputs may be obtained and analyzed to identify subject matter which a processor of the mobile device may reflect in words included in a communication generated for the user. In an embodiment, subject matter associated with a sensor data stream may be associated with a word, and the word may be used to assemble a natural language narrative communication for the user, such as a written message.

### BACKGROUND

Current mobile devices may enable a user to write e-mails, text messages, tweets, or similar messages using a keyboard, dictation, or other methods to input the words that make up the message text. The requirement for users to directly input the words in a message may be time consuming, obtrusive, and inconvenient on a mobile device. Mobile devices lack a way for a user to write without having to type or speak the words to be included in a communication.

### SUMMARY

The systems, methods, and devices of the various embodiments use a mobile device's sensor inputs to automatically draft natural language messages, such as text messages or email messages. In the various embodiments, sensor inputs may be obtained and analyzed to identify subject matter that a processor of a mobile device or server may reflect in words included in a communication generated for the user. In an embodiment, subject matter identified in a sensor data stream may be associated with a word, and the word may be used to assemble a natural language narrative communication for the user, such as a written message.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIGS. 1A-1E illustrate example operations performed by a mobile device to assemble a communication according to the various embodiments.

FIG. 2 is a communication system block diagram of a network suitable for use with the various embodiments.

FIG. 3A is a process flow diagram illustrating an embodiment method managing data stream recording.

FIG. 3B is a component block diagram of an embodiment recorded data stream.

FIG. 4 is a communications flow diagram illustrating example interactions between a video sensor, audio sensor, button press sensor, accelerometer, GPS receiver, processor, and a mobile device memory.

FIGS. 5A-5D are a process flow diagram illustrating an embodiment method for automatically assembling a communication.

FIG. 6A is a process flow diagram illustrating an embodiment method for identifying a cue.

FIG. 6B is a process flow diagram illustrating another embodiment method for identifying a cue.

FIG. 7 is a process flow diagram illustrating an embodiment method for assembling and sending a communication.

FIG. 8 is a process flow diagram illustrating an embodiment method for assembling a communication including identified words based on identified subject matter.

FIG. 9 is a component diagram of an example mobile device suitable for use with the various embodiments.

FIG. 10 is a component diagram of an example portable computer suitable for use with the various embodiments.

FIG. 11 is a component diagram of an example server suitable for use with the various embodiments

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the terms “mobile device” is used herein to refer to any or all of cellular telephones, smart phones, personal or mobile multi-media players, personal data assistants (PDA's), laptop computers, tablet computers, smart books, palm-top computers, wireless electronic mail receivers, multimedia Internet enabled cellular telephones, wireless gaming controllers, and similar personal electronic devices that include a programmable processor, memory and circuitry for obtaining sensor data streams, and identifying subject matter associated with sensor data streams.

The various embodiments include methods, mobile devices, and systems that may utilize a mobile device's sensor inputs to automatically draft natural language messages for a user, such as text messages or email messages. In the various embodiments, sensor inputs, such as camera images, sounds received from a microphone, and position information, may be analyzed to identify subject matter that may be used to automatically assemble communications for the user. In an embodiment, subject matter recognized within a sensor data stream may be associated with words and phrases that may be assembled into a natural language narrative communication for the user, such as a text or email message.

Modern mobile devices typically include various sensors, such as cameras, microphones, accelerometers, thermometers, and Global Positioning System (“GPS”) receivers, but may further include biometric sensors such as a pulse sensor. In the various embodiments, sensor data that may be gathered by the mobile device may include image, sound, movement/acceleration measurement, temperature, location, speed, time, date, heart rate, and/or respiration, and such data output from the various sensors of a mobile device may be analyzed to identify subject matter for use in generating a message. The identified subject matter may be associated with a word, and the word may be used to generate a communication. In an embodiment, each sensor may collect data and identify cues in the collected data. In an embodiment, in response to an identified cue, data from one or more sensors may be sent to a processor or server and analyzed to identify subject matter for use in automatically generating a written communication.

As an example of how an embodiment might be employed, a user may record a series of images with the user's mobile device, such as a video data stream including a plurality of video frames. The processor may analyze the video frames for recognized objects to identify subject matter in the series of images. In an embodiment, subject matter within the video frames may be identified by computer vision processing that may identify common objects in each image or frame. In an embodiment, the subject matter identified with the recognized objects may be associated with a word, such as a noun, or phrases, and a linguistic processor may assemble the associated words and phrases in the order that the images were obtained. In an embodiment, the word or words associated with the subject matter may be chosen based on a computing device user's typical speech pattern. The linguistic processor may further include additional appropriate words, such as verbs, adjectives, conjunctions, and articles, to assemble a communication, such as a text message, for the user. In another embodiment, the linguistic processor may assemble each word or phrase identified as corresponding to subject matter recognized from sensor data in an order other than that in which the images or other sensor data were obtained.

In an embodiment, a user may start and/or stop the recording of sensor outputs to generate a finite sensor data stream that may be used to assemble a communication. In another embodiment, a user's mobile device may continually record sensor outputs to generate a continuous sensor data stream that may be used to assemble ongoing communications, such as journal entries, Facebook® posts, Twitter® feeds, etc.

In the various embodiments, in addition to sensors, a mobile device may receive data from various other types of information sources, including information stored in memory of the device and/or available via a network. In an embodiment, a mobile device may determine the date and time from network signals, such as cellular network timing signals. In an embodiment, a mobile device may have access to a user database containing information about the mobile device user, such as gender, age, address, calendar events, alarms, etc. In an embodiment, a mobile device may have access to a database of user historical activity information, such as daily travel patterns, previous Internet search information, previous retail purchase information, etc. In an embodiment, a mobile device may have access to a database of user communication information, such as a user's communication style, word choices, phrase preferences, typical speech pattern, past communications, etc. In an embodiment, a mobile device may also include user settings, such as preferences, default word selections, etc. These data sources may be used by the mobile device processor in assembling a natural language communication.

In an embodiment, once the communication is assembled, the user may edit, accept, store and/or transmit the message, such as by SMS or email. Thus, the various embodiments enable the user to generate written communications without using a keyboard or dictating into the device by taking a sequence of pictures.

While example embodiments are discussed in terms of operations performed on a mobile device, the various embodiment methods may also be implemented within a system that includes a server configured to accomplish subject matter identification, word association, and/or communication assembly as a service to the mobile device. In such an embodiment, the sensor data may be collected by the mobile device and transmitted to the server. The server may identify objects and subject matter in the sensor data and identify words associated with the identified subject matter to assemble a communication. The server may then provide a draft of the communication back to the mobile device that may receive and display the communication for approval by the user. Alternatively, the server may automatically send the assembled communication to any intended recipient.

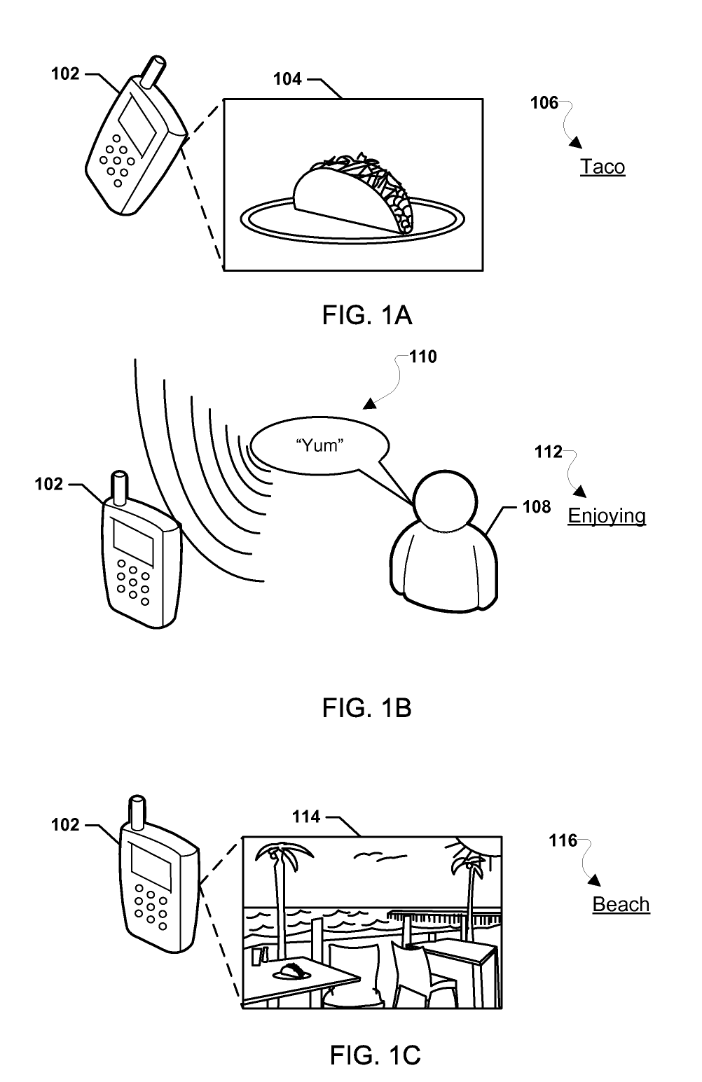

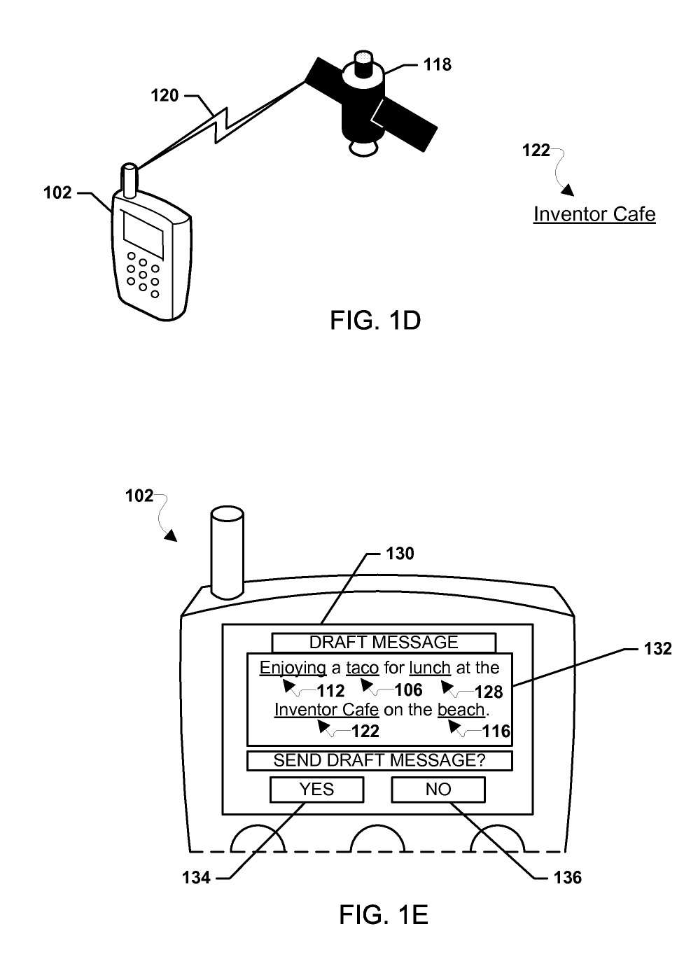

FIGS. 1A-1E illustrate example operations that may be performed by a mobile device 102 to automatically assemble a communication according to the various embodiments. In the example illustrated in FIGS. 1A-1E, a user 108 of a mobile device 102 having a taco lunch in a beachside café may desire to share his or her experience with a friend via a written message. The user 108 may initiate an automatic communication assembly application, such as with a button push on the mobile device 102. That application may cause the mobile device 102 to begin recording data output from the various sensors on the mobile device. As an example, a camera of the mobile device 102 may output video data, a microphone of the mobile device 102 may output audio data, a navigation sensor of the mobile device 102 may output position data, and a timing sensor of the mobile device 102 may output the current time, all of which may be gathered or assessed by a processor within the device.

As illustrated in FIG. 1A, the user 108 may first point the camera of the mobile device 102 at his or her plate and zoom in on his or her plate so that the plate fills a large portion of the field of view of the camera. Thus, the image frame 104 following the zoom event may include a taco on the user's plate. In an embodiment, a zoom action of the camera (i.e., the user activating a zoom function on the camera) may be interpreted as a cue, and interpreted to mean that any object imaged after the cue is intended by the user to be a subject matter for the communication. In another embodiment described below, the video image dwelling on the plate (i.e., so that a sequence of captured frames include substantially the same image) may be interpreted as a cue that sensor data should be gathered for identifying subject matter for inclusion in a communication. Having recognized a cue, the mobile device processor may analyze the video frame 104 immediately following the zoom event to identify an object in the image intended by the user to be a subject matter for the communication to be generated by the mobile device or system. As an example, the mobile device 102 may apply machine vision processing to identify an object (e.g., the taco) in the image frame 104 that the mobile device 102 may identify as subject matter. In an embodiment, the image frame 104 may be compared to an image database in order to recognize objects (e.g., a taco and a plate), and based on the results of such comparisons, a word (such as “Taco” 106) associated with the recognized object may be identified.

As illustrated in FIG. 1B, while using the camera of the mobile device 102 to record video data, the user 108 may make an utterance 110, such as “Yum.” The microphone of the mobile device 102 may detect the utterance 110 and the audio data may be passed to the mobile device processor for analysis. In an embodiment, the utterance 110 may itself be a cue, such as any number of preprogrammed voice command words. In an embodiment, the mobile device processor may identify the utterance 110 as a subject matter. As an example, to identify the utterance 110 the mobile device processor may detect the voice pattern of the user 108 and apply speech recognition processes to the utterance 110 to recognize what the user 108 said (e.g., “Yum”). In an embodiment, the subject matter of the utterance 110 may be associated with a word, such as the verb: “Enjoying” 112.

As illustrated in FIG. 1C, using the camera of the mobile device 102 the user 108 may take a panoramic photograph of the beachside café. In an embodiment, the user 108 may pause while taking video to focus on the panoramic view for a period of time. In this manner, multiple frames of video data all showing the same image 114 may be output by the camera. In an embodiment, the mobile device processor may compare the multiple frames of video data to recognize when a pre-defined number of frames contain substantially the same image 114, which the processor may interpret as a cue to process the frames to identify subject matter for a communication. When such a cue is recognized, the mobile device processor may apply machine vision processing to the images to identify an object, objects, or a scene (e.g., the beach) that the mobile device processor may identify as the subject matter intended by the user. To accomplish this, the image 114 may be compared to an image database to recognize objects and/or the scene, and based on that comparison the words or phrases, such as “Beach” 116, associated with the recognized subject matter may be identified for use in a written communication.

As illustrated in FIG. 1D, while the mobile device 102 is recording this video data, a geoposition locating circuit or function, such as a GPS receiver, may output position data, such as determined via signals 120 from a GPS navigation system 118. In an embodiment, the position data may be used by the mobile device processor as a cue and/or subject matter. For example, the position data may be compared to a point of interest database to determine the point of interest associated with the mobile device's 102 position. As an example, the position data may enable the processor to determine the restaurant, such as the Inventor Café, where the user is eating. Using this information, the device processor may identify a word or words associated with the current location, such as “Inventor Cafe” 122, that may be included in a written communication.

In an embodiment, a mobile device clock may be used to determine the time of day that may be used as a cue and/or a subject matter. In an embodiment, the mobile device clock may output the current time, and the mobile device processor may identify a word, such as “Lunch” 128, associated with the current time.

As illustrated in FIG. 1E, once the mobile device processor has selected the words Taco 106, Enjoying 112, Beach 116, Inventor Cafe 122, and Lunch 128, the processor may automatically assemble a communication including those identified words. In an embodiment, the mobile device 102 may apply natural language processing to assemble a communication including the identified words and normally associated verbs, articles, and phrases (e.g., “eating,” “a,” “at the,” etc.) as appropriate according to normal speech patterns. The mobile device 102 may display a draft message 132 on a display 130 of the mobile device 102 for review by the user. As an example, the identified words, Taco, Enjoying, Beach, Inventor Cafe, and Lunch, may be assembled into the draft message 132 “Enjoying a taco for lunch at the Inventor Cafe on the beach.” Also, the mobile device 102 may display indications 134, 136 prompting the user 108 to approve, disapprove, edit, save, etc., the draft message 132 prior to the mobile device 102 sending the message.

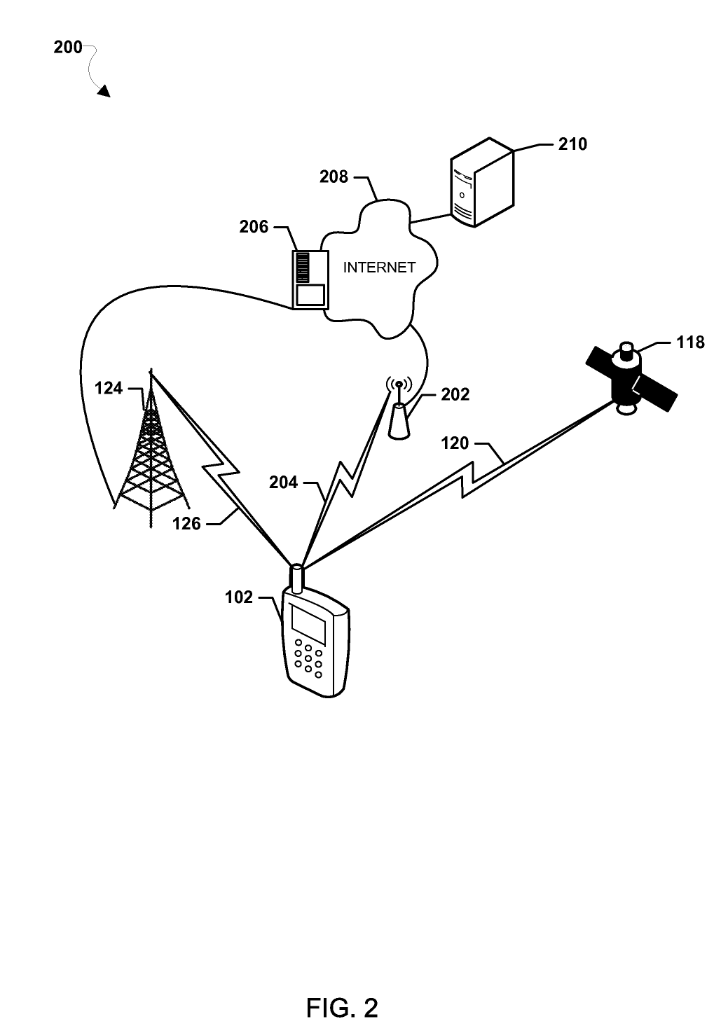

FIG. 2 illustrates a communication system 200 suitable for use with the various embodiments. The communication system 200 may include a mobile device 102 in communication with a server 210 via a wireless network 124, 202 coupled to the Internet 208. The mobile device 102 may be configured to connect to a wireless connection 204, such as a Wi-Fi connection established with a wireless access point 202, such as a Wi-Fi access point. The wireless access point 202 may connect to the Internet 208, and the server 210 may be connected to the Internet 208. In this manner, data may be exchanged between the mobile device 102 and the server 210 by methods well known in the art. Additionally, the mobile device 102 may communicate with a cellular data network 124 (e.g., CDMA, TDMA, GSM, PCS, G-3, G-4, LTE, or any other type of cellular data network) that may be in communication with a router 206 connected to the Internet 208. In this manner, data (e.g., voice calls, text messages, sensor data streams, e-mails, etc) may be exchanged between the mobile device 102 and the server 210 by any of a variety of communication networks. In an embodiment, the mobile device 102 may also include a navigation sensor (such as a GPS receiver) that receives reference signals 120 from a navigation system 118, such as GPS signals from GPS satellites, to determine its position. The mobile device 102 may also determine its position based on identifying the wireless access point 202, such as a Wi-Fi access point, which may be associated with a known position, or detecting any relatively low-power radio signal emitted from a transmitter at a fixed location, such as wireless utility meters, ad hoc wireless networks, etc.

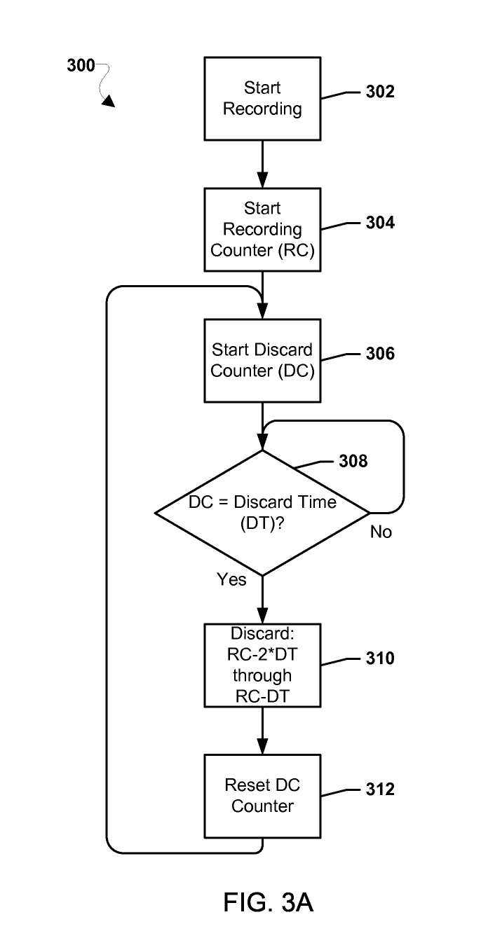

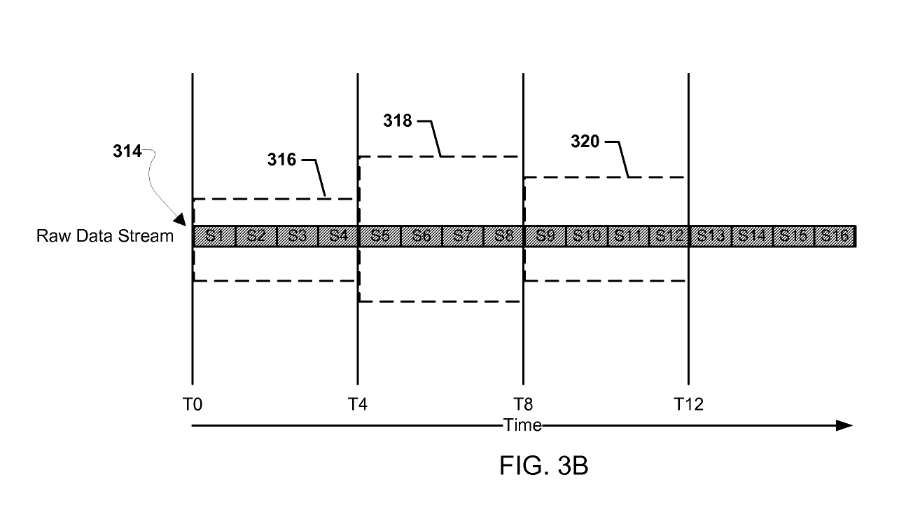

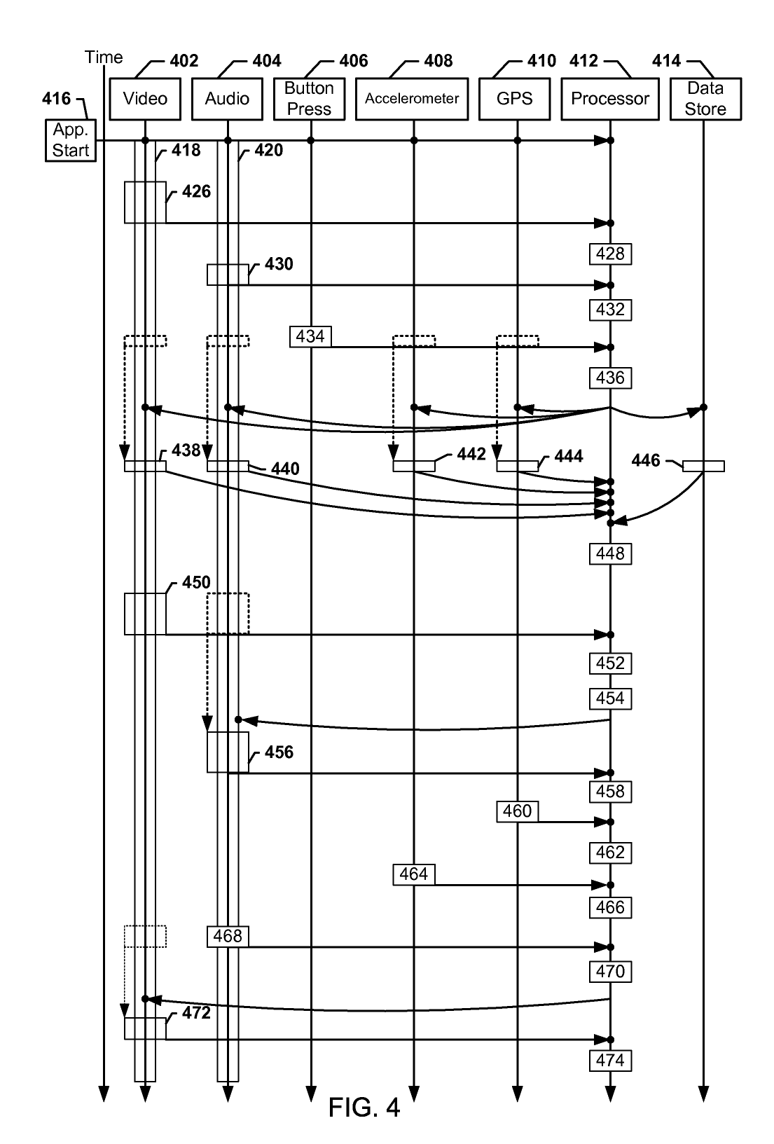

FIG. 3 illustrates an embodiment method 300 for managing data stream recording. In an embodiment, the operations of method 300 may be implemented by the processor of a mobile device. In another embodiment, the operations of method 300 may be performed by processors and controllers of the individual sensors of the mobile device themselves. In block 302, the sensor or the device processor may start recording sensor data. As an example, a sensor, such as a video camera, may start recording in response to the actuation of an automatic communication assembly application. In an embodiment, recording may include storing the raw data stream output by the sensor in a memory. In block 304, the processor may start a recording counter or clock (“RC”). In an embodiment, the recording counter/clock may be a count-up counter/clock incremented based on an internal clock of the processor. In this manner, the recording counter or clock may count/measure the time since the start of recording. In block 306, the processor may start a discard counter or clock (“DC”). In an embodiment, the discard counter/clock may be a count-up counter/clock incremented based on an internal clock of the processor.

In determination block 308, the processor may compare the value of the discard counter/clock to a discard time (“DT”) value. In an embodiment, the discard time may be equal to a period of time for which the processor may be required to maintain previously recorded sensor outputs. As an example, in embodiments in which the processor is maintains the last four seconds of recorded sensor outputs in a buffer, the discard time may be equal to four seconds. In an embodiment, the discard time may be a value stored in the memory of the mobile device. If the discard counter/clock does not equal the discard time (i.e., determination block 308=“No”), the method 300 may return to determination block 308 and continue to compare the value of the discard counter/clock to the discard time. If the discard counter/clock does equal the discard time (i.e., determination block 308=“Yes”), in block 310 the processor may discard from memory portions of the sensor output corresponding to RC-(2DT) through RC-DT. In this manner, memory overflow issues may be avoided because portions of the sensor output aged beyond the discard time may be discarded from memory. As an example, in an embodiment in which the discard time equals four seconds, every four second portion of the sensor output (e.g., raw data stream segments) recorded more than four seconds earlier may be discarded. In block 312 the processor may reset the discard counter/clock to zero, and in block 306 the processor may restart the discard counter. In this manner, a limited memory buffer of sensor outputs may be maintained while not overburdening the memory with storing all recorded sensor outputs.

FIG. 3B illustrates an example recorded sensor output, raw data stream 314, generated according to the operations of method 300 discussed above with reference to FIG. 3A. Recording of the sensor output may be started at time T0 to begin to generate raw data stream 314. At time T0 the recording counter/clock and the discard counter/clock may also be started. As time progresses, the sensor output may be recorded in segments of equal lengths of time, such as S1, S2, S3, S4, S5, S6, S7, S8, S9, S10, S11, S12, S13, S14, S15, and S16. As an example, the segments S1-S16 may be a plurality of video frames. In an embodiment in which the discard time is equal to T4, at time T4 the record counter/clock may equal T4 and the discard counter/clock may equal T4. The discard counter/clock may then be equal to the discard time, and any segments of the raw data stream 314 older than T0 may be discarded and the discard counter/clock may be reset to zero. In this manner, a buffer 316 equal to the discard time may be maintained in memory. At time T8 the record counter/clock may equal T8 and the discard counter/clock may equal T4. The discard counter/clock may then be equal to the discard time, and any segments of the raw data stream 314 older than T4 may be discarded and the DC may be reset to zero. In this manner, a buffer 318 equal to the discard time may be maintained in memory and the previous buffer 316 may be discarded. At time T12 the record counter/clock may equal T12 and the discard counter/clock may equal T4. The discard counter/clock may then be equal to the discard time, and any segments of the raw data stream 314 older than T4 may be discarded and the discard counter/clock may be reset to zero. In this manner, a buffer 320 equal to discard time may be maintained in memory and the previous buffer 318 may be discarded. In another embodiment, the video sensor may be configured with a video buffer configured to store a moving window of a finite number of captured video frames that deletes the oldest frame as each new frame is stored once the buffer is full.

FIG. 4 is a communications flow diagram illustrating the interactions that may occur between a video sensor 402, audio sensor 404, button press sensor 406, accelerometer 408, GPS receiver 410, processor 412, and data store 414 of a mobile device over time following the start of an automatic communication assembly application according to an embodiment. In the embodiment illustrated in FIG. 4, the video sensor 402, audio sensor 404, button press sensor 406, accelerometer 408, and GPS receiver 410 may each be hardware circuits of the mobile device and each may have their own logic processing capabilities enabling them to identify cues and send/receive messages to/from the processor 412. In an alternative embodiment, the processor 412 may process the data outputs of the various sensors to identify cues. Thus, a cue may be any one of a button press, a recognized sound, a gesture, a touch screen press, a zoom-in event, a zoom-out event, a stream of video including substantially the same image, a loud sound, a spoken command, an utterance, a squeeze, a tilt, or an eye capture indication. In block 416 the automatic communication assembly application may be activated (e.g., by a button press, voice command or other user input) and a notification of the start of the automatic communication assembly application may be sent to the video sensor 402, audio sensor 404, button press sensor 406, accelerometer 408, GPS receiver 410, and processor 412. As an example, the automatic communication assembly application may be activated in response to a user selection of the application, such as a touch screen tap or button press.

Upon receiving the notification of the start of the automatic communication assembly application, the video sensor 402, audio sensor 404, button press sensor 406, accelerometer 408, and GPS receiver 410 may begin to monitor sensor data in order to determine whether any cues are present in their respective sensor outputs. This monitoring of sensor data may be accomplished at the sensor (i.e., in a processor associated with the sensor such as a DSP) or within the device processor 412. Additionally, upon receiving the notification of the start of the automatic communication assembly application, the video sensor 402 may start recording a video data stream 418 and the audio sensor 404 may start recording an audio data stream 420.

The video sensor 402 (or the processor 412) may analyze a data window 426 of the video data stream 418 to determine whether the data window 426 includes a cue to begin capturing subject matter for a communication. As an example, the video sensor 402 may analyze characteristics of a sequence of images in the data window 426 to determine whether the images are similar, indicating that the camera has focused on a particular thing or view, which the sensor or the processor may identify as being a cue. In response to identifying the cue, the video sensor 402 may send the data window 426 corresponding to the cue to the processor 412. The processor may receive and store the data window 426 and in block 428 may analyze the data window 426 to identify subject matter within the data window 426. As an example, the processor 412 may apply machine vision processing to the data window 426 to identify objects within data window 426.

Similarly, the audio sensor 404 (or the processor 412) may analyze a data window 430 of the audio data stream 430 two determine whether the data window 430 includes any sounds corresponding to a cue (such as a loud sound) to begin collecting subject matter for communication. As an example, the audio sensor 404 may compare the volume of sounds within the data window 430 to a threshold volume characterizing a loud sound, which when exceeded may be interpreted as a cue to begin capturing subject matter for a communication. In response to identifying such a cue, the audio sensor 404 may send the audio data window 430 corresponding to the cue to the processor 412. The processor may receive and store the audio data window 430, and may analyze the data window 430 in block 432 to identify subject matter within the data window 430. As an example, the processor 412 may apply speech processing to the data window 430 to identify words within the data window 426 that may be interpreted as subject matter for a communication.

In block 434, the button press sensor 406 may identify a button push event and send a notification of the event to the processor 412, which may interpret the button push event as a cue to begin gathering subject matter for a communication. In response to the button press event, in block 436, the processor 412 may determine that data collection from the video sensor 402, audio sensor 404, accelerometer 408, GPS receiver 410, and data store 414 should begin, and may send a data collection trigger to the video sensor 402, audio sensor 404, accelerometer 408, GPS receiver 410, and/or data store 414 to cause the sensor(s) to begin gathering data. The data collection trigger may include a request for specific data, such as data corresponding to a specific data window that may have already been saved by the sensor. For example, a data collection trigger may request data corresponding to the video and audio data windows coinciding with the button press event identified in block 434.

The video sensor 402 may receive the data collection trigger and may send its video data window, such as a number of video frames that were captured at the time of the button press event in block 438. Similarly, the audio sensor 404 may receive the data collection trigger and may send its audio data window, such as an audio recording that was captured at the time of the button press event in block 440. The accelerometer 408 may receive the data trigger and may send a data window of acceleration data, such as accelerometer measurements taken at the time of the button press event, in block 442. The GPS receiver 410 may receive the data trigger and may send the processor current position information in block 444. The data store 414 may receive the data trigger, and in response may send one or more data elements to the processor, such as a file or data record (e.g., a calendar application data record relevant to the current day and time), in block 446. The processor 412 may receive and store the various sensor and stored data, and in block 448 may analyze the data to identify subject matter suitable for inclusion in a written communication. As an example, the processor 412 may identify objects in video frames, words in audio recordings, the current location, and/or movements (i.e., accelerations) of the device based on the received data, and may cross correlate any identified objects, words, locations, and/or movements in order to identify subject matter for a written communication.

As mentioned above, a cue to begin gathering subject matter for communication may also be recognized by a video camera, such as by detecting zoom actions and/or recognizing when the camera has focused for a period of time on a given subject matter. To accomplish this, the video sensor 402 may analyze a data window 450 of the video data stream 418 to determine whether the data window 450 constitutes or includes a cue. As an example, the video sensor 402 may analyze the sequence of frames to determine whether the subject matter is static (i.e., approximately the same image appears in all of a predetermined number of frames), which the video sensor may be configured to recognize as a cue to begin capturing subject matter or communication. In response to identifying such a cue, the video sensor 404 may send a data window 450 of recently captured video frames corresponding to the cue to the processor 412. The processor 412 may receive and store the data window 450, and in block 452 may analyze the video data window 450 to identify subject matter within the images. In block 454 the processor 412 may determine from the type of cue received (e.g., button press, video cue, etc.) whether additional data should be gathered, such as from the audio sensor 404. If the processor 412 determines that additional data should be gathered for the communication, the processor 412 may send a data trigger to the audio sensor 404 to cause it to begin recording audio data. The audio sensor 404 may receive the data collection trigger and in response begin recording an audio data window 456. Alternatively or in addition, the audio sensor 404 may send to the processor 412 a recorded audio data window 456 that corresponds to the video data window 450. Thus, the audio data sent to the processor 412 in response to a video cue may be a recording that was being made at the time the video images were taken (i.e., a rolling window of audio data), audio data that is captured after the cue, or a combination of both. The processor 412 may receive and store the audio data window 456 from the audio sensor 404, and in block 458 the processor 412 may analyze the audio data window 456 to identify subject matter that may be included within a written communication. Additionally, in block 458 the processor 412 may analyze the data included within both the video data window 450 and the audio data window 456 to identify subject matter to be included in a written communication.

The GPS receiver 410 may analyze GPS data 460 to determine whether the GPS location information should be interpreted as a cue to begin capturing subject matter for a written communication. As an example, the GPS receiver 410 may determine that the device has moved, which the processor 412 may be configured to recognize as a cue to begin capturing subject matter. As another example, the GPS receiver 410 may determine when the device has arrived at a location that the user has previously designated to be a site at which subject matter should be captured for a written communication (i.e., arriving at the location constitutes a cue to begin gathering sensor data in order to identify subject matter for a written communication). The GPS sensor 410 may send the GPS data 460 to the processor 412, which may store the data, and in block 462 may identify subject matter based upon the GPS location information. As an example, the processor 412 may compare the GPS location information to points of interest information within a data table or map application to identify subject matter that may be relevant to a written communication.

The accelerometer 408 (or the processor 412) may analyze accelerometer data to determine whether accelerations recorded within an accelerometer data window 464 corresponds to a cue to begin capturing subject matter for a written communication. As an example, the accelerometer 408 may determine whether the accelerometer data matches a predetermined pattern, such as a particular type of shaking, twisting or rolling that correspond to a cue. In response to detecting such a cue, the accelerometer 408 may send the accelerometer data window 464 (i.e., acceleration data recorded within a predetermined amount of time) to the processor 412. The processor 412 may receive and store the acceleration data window 464, and in block 466 the processor 412 may identify subject matter within the data window 464. As an example, the processor 412 may use motions indicated by the accelerometer data to identify subject matter such as whether the user is in a car, walking on a boat or other situation that may be characterized by accelerations of the mobile device.

In a further embodiment, the audio sensor 404 (or the device processor 412) may analyze an audio data stream 420 using voice recognition software to determine whether the user spoke a command or word constituting a cue to begin capturing sensor data or identifying subject matter for a written communication. As an example, the audio sensor 404 may apply voice recognition processing to the data window 468 to recognize a spoken command cueing the device to begin capturing sensor data for generating a written communication. In response to identifying a verbal command cue, the audio sensor 404 may send the cue to the processor 412. The processor 412 may receive and in block 470 determine the type of sensor data that should be captured, such as images from the video sensor 402. The types of sensor data that may be captured include image, sound, movement/acceleration measurement, temperature, location, speed, time, date, heart rate, and/or respiration. Based upon the type of sensor data that the processor 412 determines to be required, the processor may send a data trigger to the corresponding sensors, such as the video sensor 402. In response, the sensors may gather data which is returned to the processor 412 for processing. For example, in response to receiving a data collection trigger, the video sensor 402 may send a video data window 472 to the processor 412, which may analyze the video data in block 474 to identify subject matter within the video images for use in generating a written communication. In determining subject matter for the written communication, the processor 412 may consider both the spoken command and other words in conjunction with the processed video images.

In an embodiment, the subject matter identified in the various sensor data windows and any data elements that are received by the processor 412 may be used to identify subject matter that the processor may translate into words and/or phrases, which may be stored in a communication word list. As discussed in more detail below, a communication word list may be used to identify particular words corresponding to visual images, accelerometer readings, background sounds and even verbal commands, and that may be assembled into a written communication. In an embodiment, the processor 412 may assemble the written communication in real time as subject matter is identified. Also, in an embodiment, content from one or more of the various sensor data windows and data elements may be include with or within the assembled communication. For example, a written communication that includes words describing subject matter recognized within a video or still image may attach or include within the communication a portion or all of the image(s), thereby showing an image of the subject matter described in the communication.

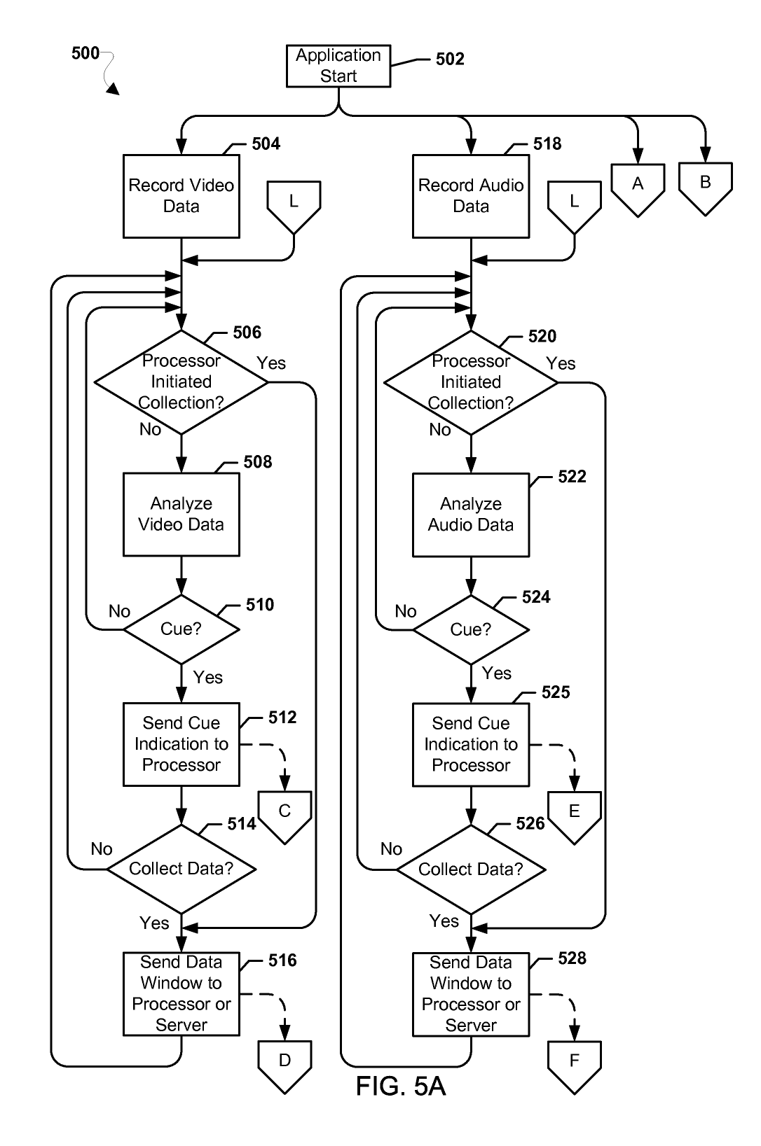

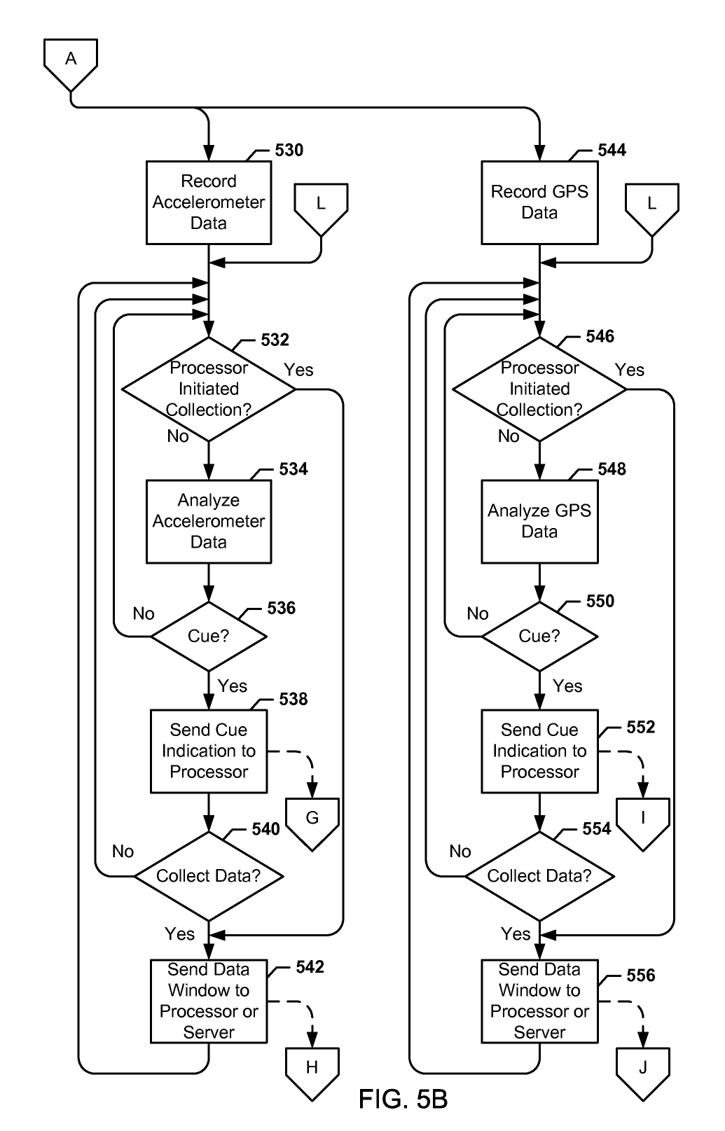

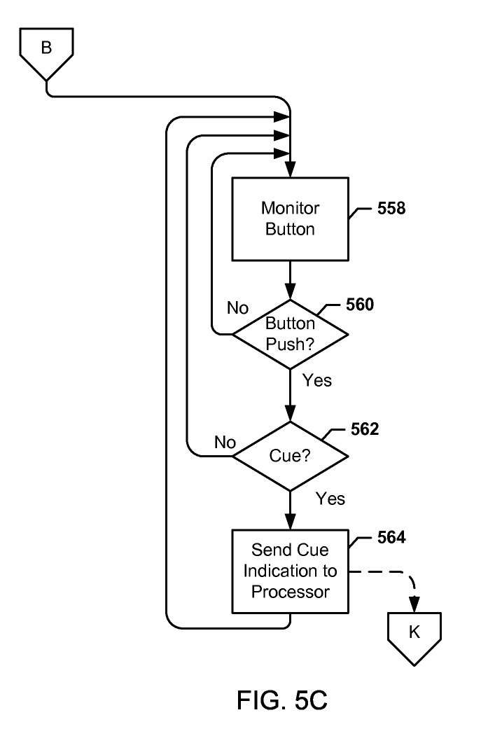

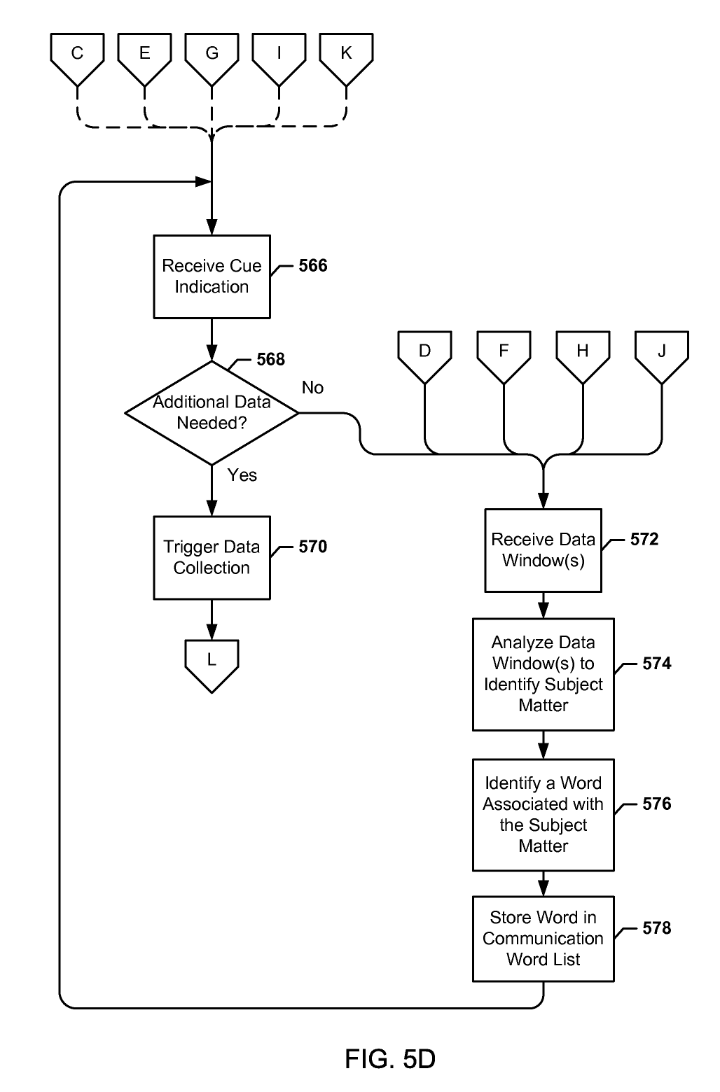

FIGS. 5A-5D illustrate an embodiment method 500 for automatically assembling a communication based upon subject matter extracted from sensor data gathered by a mobile device. In an embodiment, the operations of method 500 may be performed by the sensors and processors of a mobile device. In an alternative embodiment, the operations of method 500 may be performed by the sensors and processors of a mobile device in communication with a server remote from the mobile device. In the embodiment illustrated in FIGS. 5A-5D, the video sensor, audio sensor, button, accelerometers, and GPS receiver may each be hardware components of the mobile device, some of which may have their own logic processing capabilities (e.g., a DSP or GPS processor) enabling the sensors to identify cues and send/receive messages to/from the processor of the mobile device as described above. In an alternative embodiment, the processor of the mobile device may process the data outputs of the various sensors to identify cues and perform other sensor related logic operations. In a further embodiment, the processing of sensor data may be accomplished partially in processors associated with the circuit, the processor of the mobile device, and a remote server.

In method 500 in block 502 (see FIG. 5A), an automatic communication assembly application may start or otherwise be activated to begin generating a communication. In block 504, a video sensor of the mobile device, such as a camera, may begin recording video data. In block 518 (see FIG. 5A), an audio sensor of the mobile device, such as a microphone, may begin recording audio data. In block 530 (see FIG. 5B), an accelerometer of the mobile device may begin recording accelerometer data. In block 544 (see FIG. 5B), a GPS receiver of the mobile device may begin recording GPS data. In an embodiment, GPS data may include latitude and longitude coordinates determined based on GPS reference signals received by the GPS receiver and/or previously determined latitude and longitude coordinates associated with wireless access points, such as Wi-Fi access points, visible to the mobile device. In block 558 (see FIG. 5C) a button press sensor may begin monitoring a particular button of the mobile device.

Referring to FIG. 5A, in determination block 506, the video sensor may determine whether the processor initiated video data collection. In an embodiment, the video sensor may determine that the processor initiated collection when it receives a data collection trigger from the processor. If no data collection trigger is received (i.e., determination block 506=“No”), in block 508 the video sensor may analyze the video data to determine if the video data includes a cue to begin capturing data for use in generating a written communication. As an example, the video sensor may analyze characteristics of the video data to recognize whether the camera has dwelled on a particular scene for a predetermined number of frames. In determination block 510, the video sensor may determine whether a cue to begin capturing data is identified in the video data. If a cue is not identified in the video images (i.e., determination block 510=“No”), the video sensor may return to determination block 506 to again monitor for data capture triggers from the processor. In this manner, the video sensor may continually monitor for data capture triggers from the processor and analyze video data to identify a cue to begin capturing video data for use in identifying subject matter for written communications.

If a cue is identified by the video sensor (i.e., determination block 510=“Yes”), the video sensor may send a cue indication to the processor in block 512, and in determination block 514, the video sensor may determine whether data collection may be needed. In an embodiment, a cue identified in one data stream may not necessarily result in the video sensor sending a video data window to the processor for analysis, such as when the cue indicates or the processor determines that data is needed from other sensors (e.g., the audio sensor). The various sensors, such as the video sensor, audio sensor, accelerometer, and GPS receiver, may include logic enabling each sensor to determine whether data may be needed by the processor based on the type of cue received from the processor or recognized and sent to the processor. If no sensor data is needed by the processor (i.e., determination block 514=“No”), the video sensor may return to determination block 506 to continue to monitor for a processor data capture trigger and analyze video data to identify cues.

If the video sensor determines that video data is needed by the processor in response to the queue (i.e., determination block 514=“Yes”) or if the processor sends the video sensor a data collection trigger (i.e., determination block 506=“Yes”), in block 516 the video sensor may record video data and send a video data window to the processor before returning to determination block 506. In an embodiment, the data window may correspond to the cue identified in determination block 510. In an embodiment, each data window may have a fixed sized. Alternatively, the size of the data windows may vary based on the identified cues, device settings, and/or data collection triggers received from the processor.

In determination block 520, the audio sensor may determine whether a data collection trigger has been received from the processor. The audio sensor may determine whether the processor initiated data collection based on a received data collection trigger from the processor. If no data collection trigger is received (i.e., determination block 520=“No”) the audio sensor may analyze the audio data in block 522, such as analyzing characteristics of the audio data, and determine whether a cue is included within the audio data in determination block 524. If a cue is not identified in the audio data (i.e., determination block 524=“No”), the audio sensor may return to determination block 520. In this manner, the audio sensor may continuously await a data collection trigger from the processor and continuously analyze audio data to identify cues.

If a cue is identified in the audio data (i.e., determination block 524=“Yes”), the audio sensor may send a cue indication to the processor in block 525, and determine whether audio data collection is needed in determination block 526. If no further audio data is needed by the processor (i.e., determination block 526=“No”), the audio sensor may return to determination block 520 to continue to analyze the audio data to identify cues.

If the audio sensor determines that audio data is needed by the processor (i.e., determination block 526=“Yes”) or if the processor initiated audio data collection (i.e., determination block 520=“Yes”), the audio sensor may begin collecting audio data and send an audio data window to the processor in block 528, before returning to determination block 520. The audio data window may correspond to the cue identified in determination block 524.

Referring to FIG. 5B, in determination block 532 the accelerometer sensor may determine whether the processor initiated the collection of accelerometer data, such by determining whether a data collection trigger has been received. If no data collection trigger is received (i.e., determination block 532=“No”), in block 534 the accelerometer may analyze the stream of accelerometer data to determine if any of the data constitutes a cue to begin data collection for a written communication. As an example, the accelerometer may analyze accelerometer data to identify changes in acceleration, which may indicate a movement or a particular user input (e.g., shaking of the mobile device). In determination block 536, the accelerometer may determine whether a cue is identified in the accelerometer data. If a cue is not identified (i.e., determination block 536=“No”), the method 500 may return to determination block 532. In this manner, accelerometer data may be continually analyzed to identify cues.

If a cue is identified within the accelerometer data (i.e., determination block 540=“Yes”), the accelerometer may send a cue indication to the processor in block 542, and in determination block 540, the accelerometer may determine whether further accelerometer data collection is needed to support communication associated with the determined cue. If no further accelerometer data is needed by the processor (i.e., determination block 540=“No”), the accelerometer sensor may return to determination block 532 to continue to analyze the accelerometer data to identify cues.

If further accelerometer data is needed by the processor (i.e., determination block 540=“Yes”) or if a processor initiated accelerometer data collection (i.e., determination block 532=“Yes”), in block 542 the accelerometer may begin recording it accelerometer data and send an accelerometer data window to the processor before returning to determination block 532. In an embodiment, the accelerometer data window may correspond to the cue identified in determination block 536.

In determination block 546, the GPS receiver may determine whether the processor requested GPS location data. If the processor has not requested GPS data (i.e., determination block 546=“No”), in block 548, the GPS receiver may compare current location information to predefined location parameters to determine whether the current location constitutes a cue to begin gathering sensor data to support generating a written communication. As an example, the GPS receiver may analyze GPS data to identify whether the mobile device has changed location or arrived at a location where a communication is to be generated. In determination block 550, the GPS receiver may determine whether the current location indicates that a message should be generated (i.e., that a cue is identified in the GPS data). If not (i.e., determination block 550=“No”), the GPS receiver may return to determination block 546. In this manner, GPS data may be continually analyzed to identify location-based cues to begin collecting sensor data to support generation of written communications.

If a location-based cue is identified (i.e., determination block 550=“Yes”), the GPS receiver may send a cue indication to the processor in block 552, and in determination block 554, the GPS receiver may determine whether further location data may be needed. If no data is needed by the processor (i.e., determination block 540=“No”), the GPS receiver may return to determination block 546 to continue analzying the GPS data to identify cues.

If further location data is needed by the processor (i.e., determination block 556=“Yes”) or if the processor requested location data (i.e., determination block 546=“Yes”), in block 556 the GPS receiver may send to the processor the current location and/or a data window of locations over a period of time (e.g., which would indicate speed and direction of the mobile device), after which the GPS receiver may return to determination block 546. In an embodiment, the data window may correspond to the cue identified in determination block 550.

Referring to FIG. 5C, in determination block 560 the button press sensor may determine whether a button push has occurred. If the button was not pushed (i.e., determination block 560=“No”), in block 558 the button press sensor may continue to monitor a button of the mobile device. If the button is pushed (i.e., determination block 560=“Yes”), at determination block 562 the button press sensor may determine whether the button push indicates a cue to begin collecting sensor data to generate a written communication. As an example, the button press sensor may monitor the length of time the button is depressed, and a button depressed for more than a threshold time period may indicate a cue. If a cue is not indicated (i.e., determination block 562=“No”), in block 558 the button press sensor may continue to monitor the button of the mobile device. If a cue is indicated (i.e., determination block 564=“Yes”), in block 564 the button press sensor may send a cue indication to the processor, and in block 558 the button press sensor may continue to monitor the button for further presses.

Turning to FIG. 5D, the processor may receive cue indications sent from the video sensor, audio sensor, accelerometer, GPS receiver, and/or button press sensor in block 566. In an embodiment, the cue indication may include information about the sensor that generated the cue indication, characteristics of the data stream within which the cue was identified, timing information, and/or a sensor data window corresponding to the identified cue. At this point, the processor may proceed to analyze the sensor data, or in an alternative embodiment, may begin sending sensor data to a remote server which may perform the analysis. Thus, as part of block 566, in some embodiments, the processor may also send the received queue indications and any sensor data to a remote server. Therefore, for the following description many of the operations may be performed within a processor of the mobile device, in a remote server or partly within the processor and partly within the remote server. In determination block 568 the processor and/or server may determine from the received cue indication whether additional data is needed from the various sensors in order to generate a written communication. In an embodiment, this determination of whether additional data is needed may be based on information within the cue indication, the sensor sending the cue indication, and/or device or service settings. If additional data is needed (i.e., determination block 568=“Yes”), in block 570 the processor may request further data collection from the sensors, such as by sending data collection triggers to the appropriate sensors. In embodiments in which this determination 568 is performed by a server, part of block 570 may include the server transmitting a message to the mobile device processor identifying the types of data that need to be collected, in response to which the processor may issue the corresponding data collection triggers to a sensor or a group of sensors of the mobile device. In an embodiment, a data trigger message may include information directing the sensor to retrieve and send a specific data window and/or a data window corresponding to a specific time period to the processor and/or server.

If additional data is not needed to begin generating a communication (i.e., determination block 568=“No”) and/or if a sensor data window or windows were sent from the video sensor, audio sensor, accelerometer, and/or GPS receiver, in block 572 the processor may receive the data window(s). In embodiments in which a remote server accomplishes at least part of the data processing, in part of block 572, the mobile device processor may forward the received data windows to that server. In an embodiment, the processor and/or server may store the received data window(s) in memory. In block 574, the processor and/or server may analyze the received sensor data window(s) to identify subject matter indicated within the data that may be used in generating the written communication. As an example, the processor and/or server may apply machine vision processing to identify objects within images, apply speech recognition processing to identify words within audio data, apply voice recognition processing to identify specific speakers within audio data, identify attributes of the data that may be subject matter or related to subject matter (such as specific pixel values, or volume and pitch of audio data), analyze acceleration dated to determine whether the mobile device is moving or shaking, and/or use any location to look up or otherwise identify subject matter related to location.

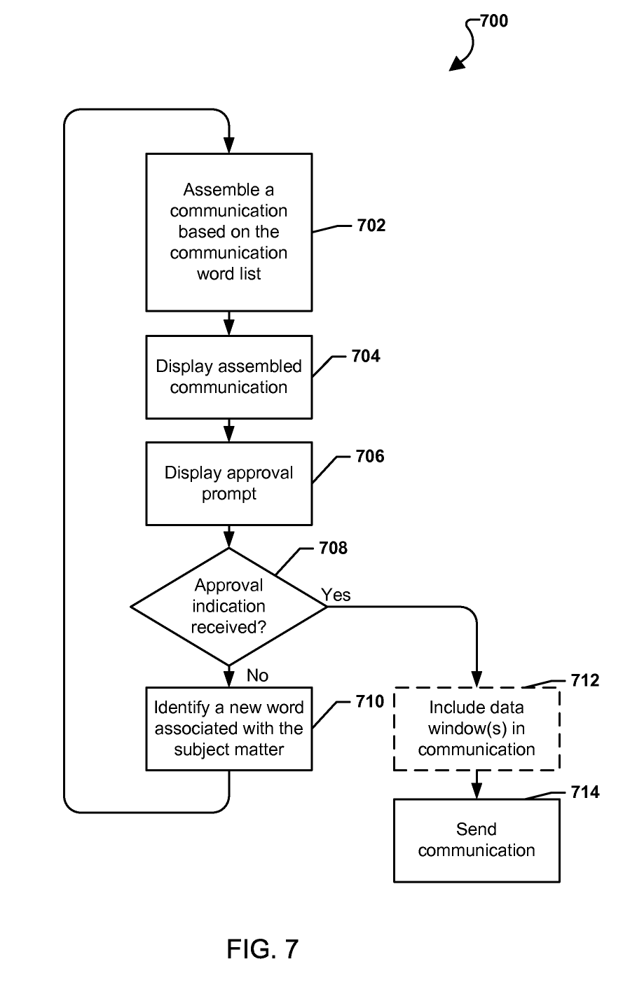

In block 576 the processor and/or server may identify a word associated with each element of subject matter recognized within the received sensor data. As an example, the processor and/or server may compare each identified subject matter to word lists, correlating subject matter and words stored in the memory of the processor and/or server in order to identify a word or phrase best associated with the subject matter. In block 578 the processor and/or server may store the word in a communication word list from which the written communication will be assembled. As described below with reference to FIG. 7, this communication word list may then be used to assemble a written communication by the processor and/or the server. In an embodiment, the communication word list may be a memory location of the processor and/or server in which all words identified for a communication may be stored. The mobile device processor and/or server may then return to block 566 to await the next cue indication and/or sensor data from the various mobile device sensors.

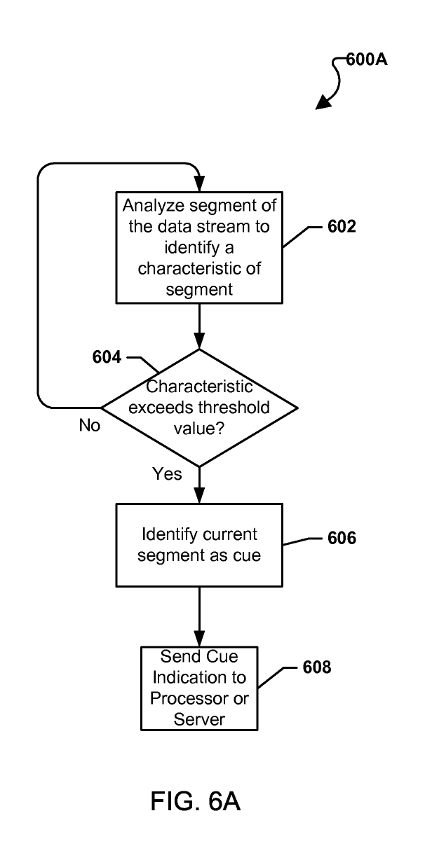

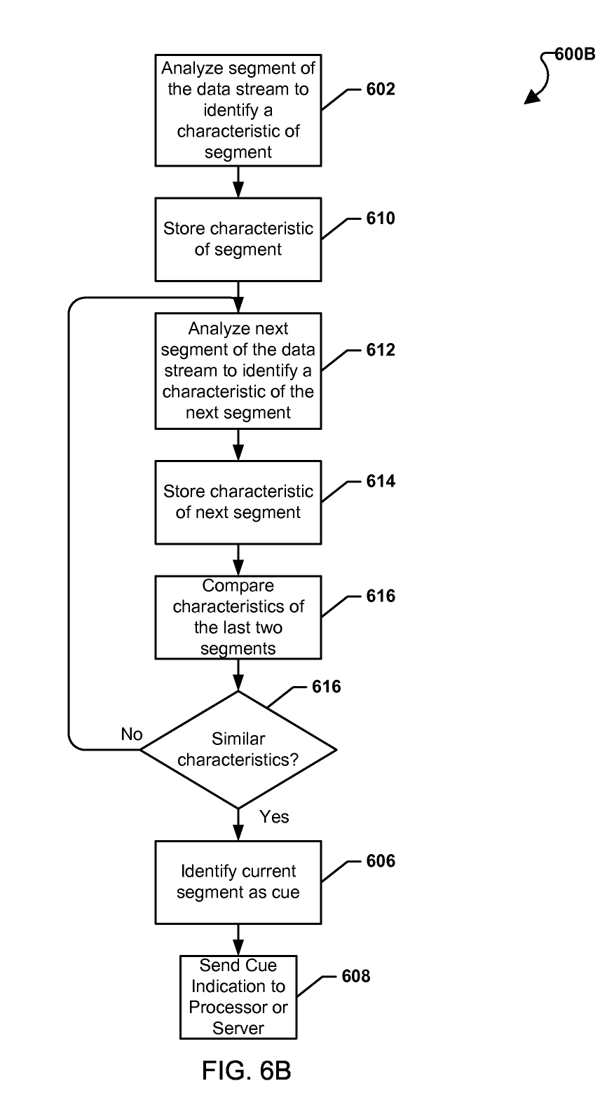

FIG. 6A illustrates an embodiment method 600A for identifying a cue in a data stream that may be implemented in one or more of the sensors. The operations of method 600A may be performed by a sensor configured to perform logic processing and/or a processor of a mobile device. In block 602 the sensor/processor may analyze a segment of the sensor data stream to identify a characteristic of the data segment. As examples, in a video data stream the sensor/processor may identify pixel values, in an audio data stream the sensor/processor may identify volume or pitch, in an accelerometer data stream the sensor/processor may identify accelerations. In determination block 604 the sensor/processor may determine whether the characteristic of the data segment exceeds a threshold value or matches a pattern within a threshold error value. In an embodiment, the threshold value or threshold error value may be a value stored in a memory of the sensor/processor that is used to identify sensor characteristics corresponding to a cue in the particular sensor data. If the characteristic of the data segment does not exceed the threshold value (i.e., determination block 604=“No”), in block 602 the sensor/processor may analyze the next segment of the data stream. If the characteristic of the data segment does exceed the threshold value (i.e., determination block 606=“Yes”), in block 606 the sensor/processor may identify the current data segment as containing a cue corresponding to the threshold value. As discussed above, in block 608 the sensor/processor may send a cue indication to the processor or server.

FIG. 6B illustrates an embodiment method 600B for identifying a cue in a data stream similar to method 600A discussed above with reference to FIG. 6A, except that in method 600B the sensor/processor may compare characteristics of two data segments to identify a cue. As discussed above, in block 602 the sensor/processor may analyze a segment of the data stream to identify a characteristic of the data segment. In block 610 the sensor/processor may store the characteristic of the data segment in local memory. In block 612 the sensor/processor may analyze the next segment of the data stream to identify a characteristic of the next data segment. In block 614 the sensor/processor may store the characteristic of the next data segment in the local memory. In block 616 the sensor/processor may compare the characteristics of the two stored data segments. In determination block 616 the sensor/processor may determine whether the two data segments have similar characteristics. As an example, the sensor/processor may compare the differences between the two data segments to a set tolerance value stored in memory to determine whether the two stored data segments exhibit similarities within the set tolerance. If the characteristics of the two stored data segments are not similar (i.e., determination block 616=“No”), the sensor/processor may discard the older data segment and return to block 612 to compare the next data segment to the last data segment. In this manner, sequential data segments may be compared to continually monitor the sensor data stream for a cue based upon similar characteristics within a stream of sensor data. If the characteristics of the two stored sensor data segments are similar within the set tolerance (i.e., determination block 616=“Yes”), in block 606 the sensor/processor may identify the current segment as a cue (which may depend upon the tolerance that is satisfied), and in block 608 the sensor/processor may send a cue indication to the processor or server.

FIG. 7 illustrates an embodiment method 700 for assembling a communication based on the communication word list generated from subject matter recognized within the gathered sensor data. As discussed above, the operations of method 700 may be performed by a processor of a mobile device and/or a server in communication with the mobile device. The operations of method 700 may be performed by a processor of a mobile device and/or a server in communication with the mobile device in real time as sensor data is gathered from a mobile device. In method 700 in block 702 the processor/server may assemble a communication based on the communication word list. As discussed further below, assembling a communication may include combining the identified subject matter descriptive words and phrases within the word list with phrases and additional words consistent with common linguistic rules to generate a communication for the user of the mobile device. This operation may utilize linguistic rules and language patterns that are consistent with those of the user, so that the generated written communication sounds was written by the user. In block 704 the processor/server may cause the assembled communication to be displayed a display of the mobile device. In embodiments in which the communication is generated in the server, the operations of block 704 include transmitting the generated communication to the mobile device to enable the processor to display the communication. In block 706 the processor/server may display a prompt on the mobile device to enable the user to approve, edit, or discard the recommended communication. In determination block 708 the processor may determine whether a user approval input was received in the mobile device. If the user disapproved of the communication (i.e., determination block 710=“No”), in block 710 the processor/server may identify a new word or words associated with the identified subject matter, and return to block 702 to assemble a new communication based on the new words.

If the user approves the generated communication (i.e., determination block 710=“Yes”), in an optional embodiment, in block 712 the processor/server may include data window(s) in the assembled communication for adding in some of the sensor data, such as an image, video or sound. In this manner, an enriched media communication may be assembled automatically, such as a story-boarded message. Such an enriched media communication may be assembled by the processor and/or the server since the sensor data corresponding to the identified subject matter is already stored in memory. Thus, when the user approves the communication, that action informs the processor/server of the subject matter that is approved for the communication. In response, the processor/server may select a portion of the sensor data to include in the communication. In block 714 the mobile device processor or the server may send the communication to an intended recipient. In an embodiment, the message may be transmitted directly from the mobile device, such as an SMS, MMS or e-mail message. In an embodiment in which the server generates the written communication, the server may transmit a message directly, bypassing the need for the mobile device to use its service plan for transmitting the generated message.

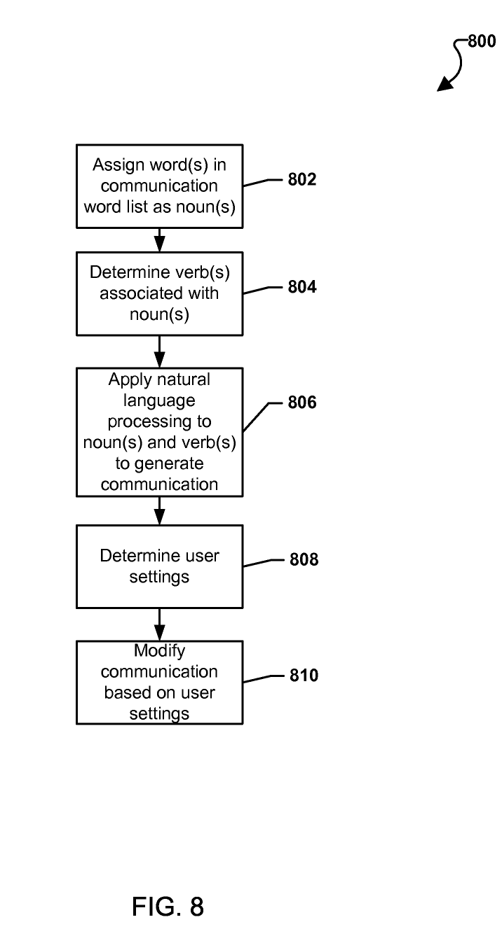

FIG. 8 illustrates an embodiment method 800 for assembling a communication including the identified word based on the identified subject matter that may be used in conjunction with the various embodiment methods discussed above. In block 802, the mobile device or the server may assign a word or words to recognize subject matter, and store the words in the communication word list as described above. Typically, subject matter description words will be nouns. In block 804, the mobile device or the server may determine a verb and/or verbs associated with the noun(s) in the communication word list. In an embodiment, the memory of the mobile device or the server may include a data table including lists of verbs associated with various nouns, and the mobile device or server may determine the verb associated with the noun by referencing the data table resident in memory. Also, verbs may be selected for use in conjunction with the nouns in the word list based on linguistic rules, which may be personalized to the linguistic patterns of the user. In block 806, the mobile device or the server may apply natural language processing to the noun(s) and the verb(s) to generate a communication. In an embodiment, natural language processing may include applying linguistic rules to choose a verb from among multiple associated verbs. In a further embodiment, natural language processing may apply linguistic rules to include appropriate pronouns, conjunctions, adverbs, articles, pronouns, adjectives, and/or punctuation, as necessary to generate a communication. In an embodiment, natural language processing may include applying communication templates stored in a memory of the mobile device or the server that may be associated with specific nouns and/or verbs. Again, the linguistic rules and the communication templates may be tailored to reflect the user's own linguistic patterns, so that the generated communication sounds as if the user was the true author.

In block 808 the mobile device or the server may determine the user settings related to generating communications. In an embodiment, user settings may include restrictions on word use, grammar rules to follow, speech styles to apply, and/or intended recipient restrictions related to generated communications. As an example, a user setting may designate formal speech patterns for communications addressed to the user's boss, and informal speech patterns for communications addressed to co-workers. In block 810, the mobile device or the server may modify the communication based on the determined user settings. As an example, the mobile device may modify a communication by removing profanity or by adding a formal greeting based on the intended recipient.

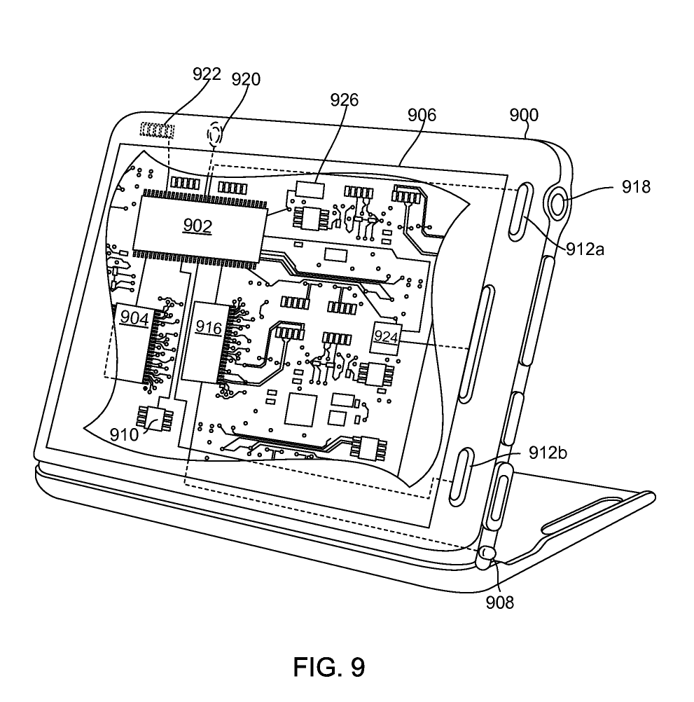

The various embodiments may be implemented in any of a variety of mobile devices, an example of which is illustrated in FIG. 9. For example, the mobile device 900 may include a processor 902 coupled to internal memories 904 and 910. Internal memories 904 and 910 may be volatile or non-volatile memories, and may also be secure and/or encrypted memories, or unsecure and/or unencrypted memories, or any combination thereof. The processor 902 may also be coupled to a touch screen display 906, such as a resistive-sensing touch screen, capacitance-sensing touch screen infrared sensing touch screen, or the like. Additionally, the display of the mobile device 900 need not have touch screen capability. Additionally, the mobile device 900 may have one or more antenna 908 for sending and receiving electromagnetic radiation that may be connected to a wireless data link and/or cellular telephone transceiver 916 coupled to the processor 902. The mobile device 900 may also include physical buttons 912a and 912b for receiving user inputs. The mobile device 900 may also include a power button 918 for turning the mobile device 900 on and off. Additionally, the mobile device 900 may include a camera 920 coupled to the processor 902 for recording images and a microphone 922 coupled to the processor 902 for recording sound. The mobile device 900 may include an accelerometer and/or gyroscope sensor 924 coupled to the processor 902 for detecting accelerations and/or orientation with respect to the center of the earth. A position sensor 926, such as a GPS receiver, may also be coupled to the processor 902 for determining position.

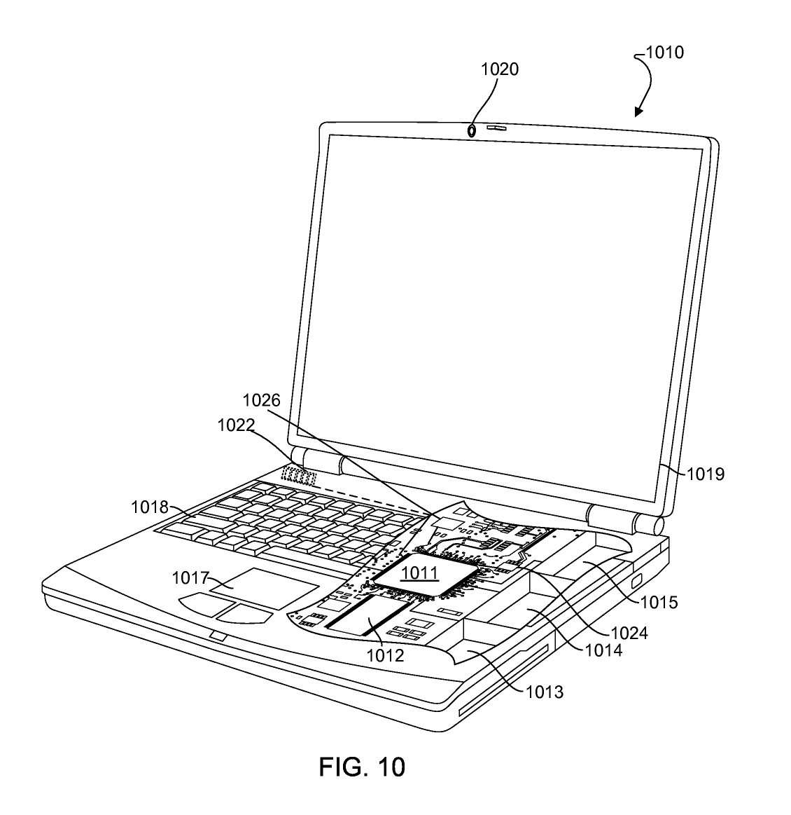

The various embodiments described above may also be implemented within a variety of personal computing devices, such as a laptop computer 1010 as illustrated in FIG. 10. Many laptop computers include a touch pad touch surface 1017 that serves as the computer's pointing device, and thus may receive drag, scroll, and flick gestures similar to those implemented on mobile computing devices equipped with a touch screen display and described above. A laptop computer 1010 will typically include a processor 1011 coupled to volatile memory 1012 and a large capacity nonvolatile memory, such as a disk drive 1013 of Flash memory. The computer 1010 may also include a floppy disc drive 1014 and a compact disc (CD) drive 1015 coupled to the processor 1011. The computer device 1010 may also include a number of connector ports coupled to the processor 1011 for establishing data connections or receiving external memory devices, such as a USB or FireWire® connector sockets, or other network connection circuits for coupling the processor 1011 to a network. Additionally, the computer device 1010 may include a camera 1020 coupled to the processor 1011 for recording images and a microphone 1022 coupled to the processor 1011 for recording sound. The computer device 1010 may include an accelerometer and/or gyroscope sensor 1024 coupled to the processor 1011 for detecting accelerations and/or orientation with respect to the center of the earth. A position sensor 1026, such as a GPS receiver, may also be coupled to the processor 1011 for determining position. In a notebook configuration, the computer housing includes the touchpad 1017, the keyboard 1018, the camera 1020, and microphone 1022, and the display 1019 all coupled to the processor 1011. Other configurations of the computing device may include a computer mouse or trackball coupled to the processor (e.g., via a USB input), as are well known, which may also be used in conjunction with the various embodiments.

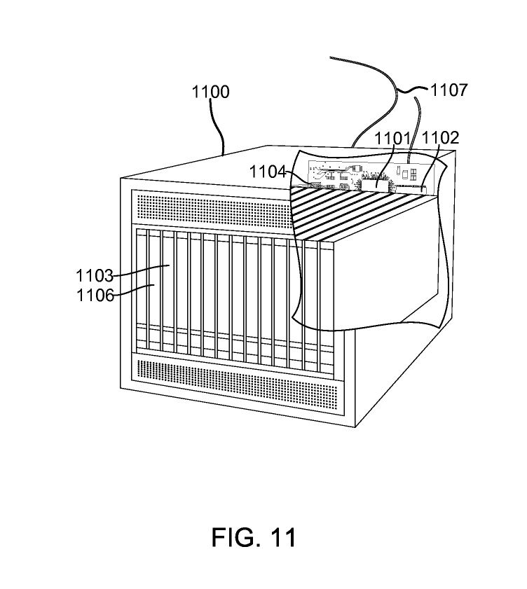

The various embodiments may also be implemented on any of a variety of commercially available server devices, such as the server 1100 illustrated in FIG. 11. Such a server 1100 typically includes a processor 1101 coupled to volatile memory 1102 and a large capacity nonvolatile memory, such as a disk drive 1103. The server 1100 may also include a floppy disc drive, compact disc (CD) or DVD disc drive 1104 coupled to the processor 1101. The server 1100 may also include network access ports 1106 coupled to the processor 1101 for establishing network interface connections with a network 1107, such as a local area network coupled to other broadcast system computers and servers.

The processors 902, 1011, and 1101 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory 904, 910, 1012, 1013, 1102, and 1103 before they are accessed and loaded into the processors 902, 1011, and 1101. The processors 902, 1011, and 1101 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 902, 1011, and 1101 including internal memory or removable memory plugged into the device and memory within the processor 902, 1011, and 1101 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more processor-executable instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for communicating using a computing device, comprising:
obtaining sensor data from one or more sensors within the computing device;
analyzing the sensor data to determine whether the data includes a cue that a written communication should be generated;
analyzing the sensor data to identify subject matter for inclusion in a written communication;
identifying a word associated with the identified subject matter; and
automatically assembling a communication including the identified word based on the identified subject matter.

2. The method of claim 1, wherein a cue is one of a button press, a recognized sound, a gesture, a touch screen press, a zoom-in event, a zoom-out event, a stream of video including substantially the same image, a loud sound, a spoken command, an utterance, a squeeze, a tilt, or an eye capture indication.

3. The method of claim 1, wherein the sensor data includes one or more of an image, sound, movement/acceleration measurement, temperature, location, speed, time, date, heart rate, and/or respiration.

4. The method of claim 1, wherein analyzing the sensor data to determine whether it includes a cue that a written communication should be generated comprises:
analyzing a segment of the sensor data to identify a characteristic of the data segment;
comparing the characteristic of the data segment to a threshold value;
determining whether the characteristic of the segment matches or exceeds the threshold value; and
identifying the segment as the cue in response to the characteristic of the segment exceeding the threshold value.

5. The method of claim 4, wherein the sensor data is a video data stream and the data segment is a video frame.

6. The method of claim 1, wherein the sensor data is a video data stream and comprises a plurality of video frames, and
wherein analyzing the sensor data to determine whether it includes a cue that a written communication should be generated comprises:
analyzing each video frame of the plurality of video frames to identify a characteristic of each video frame;
comparing the characteristics of each video frame of the plurality of video frames to the characteristic of another video frame of the plurality of video frames;
determining if the characteristics of any video frames of the plurality of video frames are similar; and
identifying the video frames with similar characteristics as the cue in response to the characteristics of any video frames of the plurality of video frames being determined as similar.

7. The method of claim 1, further comprising:
recording a portion of the sensor data; and
analyzing the recorded portion of the sensor data to identify other subject matter,
wherein automatically assembling a communication including the identified word based on the identified subject matter comprises using the identified other subject matter.

8. The method of claim 1, wherein assembling a communication including the identified word based on the identified subject matter is performed, at least in part, using natural language processing.

9. The method of claim 1, wherein automatically assembling a communication including the identified word based on the identified subject matter further comprises assembling the communication including at least a portion of the sensor data.

10. The method of claim 1, wherein identifying a word associated with the subject matter includes using a word associated with a typical speech pattern of a user of the computing device.

11. The method of claim 1, wherein identifying a word associated with the subject matter and automatically assembling a communication including the identified word based on the identified subject matter are accomplished on a mobile device.

12. The method of claim 1, further comprising transmitting a portion of the sensor data to a server in response to recognizing a cue,
wherein identifying a word associated with the subject matter and automatically assembling a communication including the identified word based on the identified subject matter are done on the server.

13. The method of claim 12, further comprising transmitting the assembled communication to the computing device.

14. A computing device, comprising:
means for obtaining sensor data from one or more sensors within the computing device;
means for analyzing the sensor data to determine whether the data includes a cue that a written communication should be generated;
means for analyzing the sensor data to identify subject matter for inclusion in a written communication;
means for identifying a word associated with the identified subject matter; and
means for automatically assembling a communication including the identified word based on the identified subject matter.

15. The computing device of claim 14, wherein a cue is one of a button press, a recognized sound, a gesture, a touch screen press, a zoom-in event, a zoom-out event, a stream of video including substantially the same image, a loud sound, a spoken command, an utterance, a squeeze, a tilt, or an eye capture indication.

16. The computing device of claim 14, wherein the sensor data includes one or more of an image, sound, movement/acceleration measurement, temperature, location, speed, time, date, heart rate, and/or respiration.

17. The computing device of claim 14, wherein means for analyzing the sensor data to determine whether it includes a cue that a written communication should be generated comprises:
means for analyzing a segment of the sensor data to identify a characteristic of the data segment;
means for comparing the characteristic of the data segment to a threshold value;
means for determining whether the characteristic of the segment matches or exceeds the threshold value; and
means for identifying the segment as the cue in response to the characteristic of the segment exceeding the threshold value.

18. The computing device of claim 17, wherein the sensor data is a video data stream and the data segment is a video frame.

19. The computing device of claim 14, wherein the sensor data is a video data stream and comprises a plurality of video frames, and
wherein means for analyzing the sensor data to determine whether it includes a cue that a written communication should be generated comprises:
means for analyzing each video frame of the plurality of video frames to identify a characteristic of each video frame;
means for comparing the characteristics of each video frame of the plurality of video frames to the characteristic of another video frame of the plurality of video frames;
means for determining if the characteristics of any video frames of the plurality of video frames are similar; and
means for identifying the video frames with similar characteristics as the cue in response to the characteristics of any video frames of the plurality of video frames being determined as similar.

20. The computing device of claim 14, further comprising:
means for recording a portion of the sensor data; and
means for analyzing the recorded portion of the sensor data to identify other subject matter,
wherein means for automatically assembling a communication including the identified word based on the identified subject matter comprises means for using the identified other subject matter.

21. The computing device of claim 14, wherein means for assembling a communication including the identified word based on the identified subject matter comprises means for assembling a communication using natural language processing.

22. The computing device of claim 14, wherein means for assembling a communication including the identified word based on the identified subject matter further comprises means for assembling the communication including at least a portion of the sensor data.

23. The computing device of claim 14, wherein means for identifying a word associated with the subject matter comprises means for using a word associated with a typical speech pattern of a user of the computing device.

24. The computing device of claim 14, wherein computing device is a mobile device.

25. A computing device, comprising:
a memory;
one or more sensors; and
a processor coupled to the memory and the one or more sensors, wherein the processor is configured with processor-executable instructions to perform operations comprising:
obtaining sensor data from the one or more sensors within the computing device;
analyzing the sensor data to determine whether the data includes a cue that a written communication should be generated;
analyzing the sensor data to identify subject matter for inclusion in a written communication;
identifying a word associated with the identified subject matter; and
automatically assembling a communication including the identified word based on the identified subject matter.

26. The computing device of claim 25, wherein a cue is one of a button press, a recognized sound, a gesture, a touch screen press, a zoom-in event, a zoom-out event, a stream of video including substantially the same image, a loud sound, a spoken command, an utterance, a squeeze, a tilt, or an eye capture indication.

27. The computing device of claim 25, wherein the sensor data includes one or more of an image, sound, movement/acceleration measurement, temperature, location, speed, time, date, heart rate, and/or respiration.

28. The computing device of claim 25, wherein the processor is configured with processor-executable instructions to perform operations such that analyzing the sensor data to determine whether it includes a cue that a written communication should be generated comprises:
analyzing a segment of the sensor data to identify a characteristic of the data segment;
comparing the characteristic of the data segment to a threshold value;
determining whether the characteristic of the segment matches or exceeds the threshold value; and
identifying the segment as the cue in response to the characteristic of the segment exceeding the threshold value.

29. The computing device of claim 28, wherein the sensor data is a video data stream and the data segment is a video frame.

30. The computing device of claim 25, wherein the sensor data is a video data stream and comprises a plurality of video frames, and
wherein the processor is configured with processor-executable instructions to perform operations such that analyzing the sensor data to determine whether it includes a cue that a written communication should be generated comprises:
analyzing each video frame of the plurality of video frames to identify a characteristic of each video frame;
comparing the characteristics of each video frame of the plurality of video frames to the characteristic of another video frame of the plurality of video frames;
determining if the characteristics of any video frames of the plurality of video frames are similar; and
identifying the video frames with similar characteristics as the cue in response to the characteristics of any video frames of the plurality of video frames being determined as similar.

31. The computing device of claim 25, wherein the processor is configured with processor-executable instructions to perform operations further comprising:
recording a portion of the sensor data; and
analyzing the recorded portion of the sensor data stream to identify other subject matter,
wherein the processor is configured with processor-executable instructions to perform operations such that automatically assembling a communication including the identified word based on the identified subject matter comprises using the identified other subject matter.

32. The computing device of claim 25, wherein the processor is configured with processor-executable instructions to perform operations such that assembling a communication including the identified word based on the identified subject matter is performed, at least in part, using natural language processing.

33. The computing device of claim 25, wherein the processor is configured with processor-executable instructions to perform operations such that assembling a communication including the identified word based on the identified subject matter further comprises assembling the communication including at least a portion of the sensor data.

34. The computing device of claim 25, wherein the processor is configured with processor-executable instructions to perform operations such that identifying a word associated with the subject matter includes using a word associated with a typical speech pattern of a user of the computing device.

35. The computing device of claim 25, wherein the computing device is a mobile device.

36. A non-transitory processor-readable storage medium having stored thereon processor-executable instructions configured to cause a processor to perform operations; comprising:
obtaining sensor data from one or more sensors within a computing device;
analyzing the sensor data to determine whether the data includes a cue that a written communication should be generated;
analyzing the sensor data to identify subject matter for inclusion in a written communication;
identifying a word associated with the identified subject matter; and
automatically assembling a communication including the identified word based on the identified subject matter.

37. The non-transitory processor-readable storage medium of claim 36, wherein the stored processor-executable instructions are configured to cause a processor to perform operations such that a cue is one of a button press, a recognized sound, a gesture, a touch screen press, a zoom-in event, a zoom-out event, a stream of video including substantially the same image, a loud sound, a spoken command, an utterance, a squeeze, a tilt, or an eye capture indication.

38. The non-transitory processor-readable storage medium of claim 36, wherein the stored processor-executable instructions are configured to cause a processor to perform operations such that the sensor data includes one or more of an image, sound, movement/acceleration measurement, temperature, location, speed, time, date, heart rate, and/or respiration.

39. The non-transitory processor-readable storage medium of claim 36, wherein the stored processor-executable instructions are configured to cause the processor to perform operations such that analyzing the sensor data to determine whether it includes a cue that a written communication should be generated comprises:
analyzing a segment of the sensor data to identify a characteristic of the data segment;
comparing the characteristic of the data segment to a threshold value;
determining whether the characteristic of the segment matches or exceeds the threshold value; and
identifying the segment as the cue in response to the characteristic of the segment exceeding the threshold value.

40. The non-transitory processor-readable storage medium of claim 39, wherein the stored processor-executable instructions are configured to cause a processor to perform operations such that the sensor data is a video data stream and the data segment is a video frame.

41. The non-transitory processor-readable storage medium of claim 36, wherein the stored processor-executable instructions are configured to cause the processor to perform operations such that:
the sensor data is a video data stream and comprises a plurality of video frames; and
analyzing the sensor data to determine whether it includes a cue that a written communication should be generated comprises:
analyzing each video frame of the plurality of video frames to identify a characteristic of each video frame;
comparing the characteristics of each video frame of the plurality of video frames to the characteristic of another video frame of the plurality of video frames;
determining if the characteristics of any video frames of the plurality of video frames are similar; and
identifying the video frames with similar characteristics as the cue in response to the characteristics of any video frames of the plurality of video frames being determined as similar.

42. The non-transitory processor-readable storage medium of claim 36, wherein the stored processor-executable instructions are configured to cause a processor to perform operations further comprising:
recording a portion of the sensor data stream; and
analyzing the recorded portion of the sensor data to identify other subject matter,
wherein the stored processor-executable instructions are configured to cause a processor to perform operations such that automatically assembling a communication including the identified word based on the identified subject matter comprises using the identified other subject matter.

43. The non-transitory processor-readable storage medium of claim 36, wherein the stored processor-executable instructions are configured to cause the processor to perform operations such that assembling a communication including the identified word based on the identified subject matter is performed, at least in part, using natural language processing.

44. The non-transitory processor-readable storage medium of claim 36, wherein the stored processor-executable instructions are configured to cause the processor to perform operations such that automatically assembling a communication including the identified word based on the identified subject matter further comprises assembling the communication including at least a portion of the sensor data.

45. The non-transitory processor-readable storage medium of claim 36, wherein the stored processor-executable instructions are configured to cause the processor to perform operations such that identifying a word associated with the subject matter includes using a word associated with a typical speech pattern of a user of the computing device.

46. A system for communicating using a computing device, comprising:
means for obtaining sensor data from one or more sensors within the computing device;
means for analyzing the sensor data to determine whether the data includes a cue that a written communication should be generated;
means for transmitting a portion of the sensor data to a server in response to recognizing a cue;
means for analyzing, on the server, the sensor data to identify subject matter for inclusion in a written communication;
means for identifying, on the server, a word associated with the identified subject matter; and
means for automatically assembling, on the server, a communication including the identified word based on the identified subject matter.

47. The system of claim 46, further comprising means for transmitting the assembled communication to the computing device.

48. The system of claim 46, wherein the computing device is a mobile device.

49. A system, comprising:
a computing device, comprising:
a memory;
one or more sensors; and
a device processor coupled to the memory and the one or more sensors; and
a server comprising a server processor,
wherein the device processor is configured with processor-executable instructions to perform operations comprising:
obtaining sensor data from the one or more sensors within the computing device;
analyzing the sensor data to determine whether the data includes a cue that a written communication should be generated; and
transmitting a portion of the sensor data to the server in response to recognizing a cue,
wherein the server processor is configured with processor-executable instructions to perform operations comprising:
analyzing the sensor data to identify subject matter for inclusion in a written communication;
identifying a word associated with the identified subject matter; and
automatically assembling a communication including the identified word based on the identified subject matter.

50. The system of claim 49, wherein the server processor is configured with processor-executable instructions to perform operations further comprising transmitting the assembled communication to the computing device.

51. The system of claim 49, wherein the computing device is a mobile device.
